(19) United States
(12) Patent Application Publication
(10) Pub. No.: US 2013/0096963 A1
(43) Pub. Date: Apr. 18, 2013

(54) CHECK-IN SYSTEM AND METHOD FOR LODGING ESTABLISHMENTS

(71) Applicants: Jack W. Craig, Oviedo, FL (US); Rafael Yepez, Duluth, GA (US)

(72) Inventors: Jack W. Craig, Oviedo, FL (US); Rafael Yepez, Duluth, GA (US)

(73) Assignee: NCR CORPORATION, Duluth, GA (US)

(21) Appl. No.: 13/275,788

(22) Filed: Oct. 18, 2011

(51) Int. Cl. G06Q 10/02

(52) U.S. Cl. 705/5

(57) ABSTRACT

A check-in system and method for lodging establishments which facilitates faster check-in. An example method includes creating a record of a reservation for a prospective guest including contact information associated with a mobile communication device of the prospective guest, determining from the record that the first night of the reservation is within a predetermined number of days, sending a message to the mobile communication device of the prospective guest using the contact information, the message including a check-in reminder and a hyperlink to a check-in web page, providing the check-in web page to the mobile communication device in response to selection of the hyperlink by the prospective guest, receiving check-in information entered into the check-in web page by the guest from the mobile communication device, and providing a confirmation web page including confirmation details of the reservation and a confirmation code containing reservation information.

### BACKGROUND

The present invention relates to guest management systems in hotels and other lodging establishments, and more specifically to a check-in system and method for lodging establishments.

Lodging establishments are looking for ways to offer guests the ability to check-in on-line via the World Wide Web (WWW) without having to stop at the front desk and wait in line to get a key and without requiring the lodging establishments to upgrade door locks.

Therefore, it would be desirable to provide a check-in system and method which allows a guest to perform some check-in tasks prior to arriving at a lodging establishment.

### SUMMARY

In accordance with the teachings of the present invention, a check-in system and method for lodging establishments is provided.

An example method includes creating a record of a reservation for a prospective guest including contact information associated with a mobile communication device of the prospective guest, determining from the record that the first night of the reservation is within a predetermined number of days, sending a message to the mobile communication device of the prospective guest using the contact information, the message including a check-in reminder and a hyperlink to a check-in web page, providing the check-in web page to the mobile communication device in response to selection of the hyperlink by the prospective guest, receiving check-in information entered into the check-in web page by the guest from the mobile communication device, and providing a confirmation web page including confirmation details of the reservation and a confirmation code containing reservation information.

### BRIEF DESCRIPTION OF THE DRAWINGS

FIG. 1 is a block diagram of a lodging management system;

FIG. 2 is an example kiosk within the lodging management system;

FIG. 3 illustrates an example deployment of the kiosk on a front desk;

FIG. 4 illustrates an example deployment of the kiosk within a pedestal;

FIG. 5 is a flow diagram illustrating a portion of the check-in process;

FIG. 6 illustrates a mobile communication device displaying a message relating to check-in;

FIG. 7 illustrates the mobile communication device displaying a first portion of a web page relating to check-in;

FIG. 8 illustrates the mobile communication device displaying a second portion of a web page relating to check-in;

FIG. 9 illustrates a mobile communication device displaying a message confirming check-in.

### DETAILED DESCRIPTION

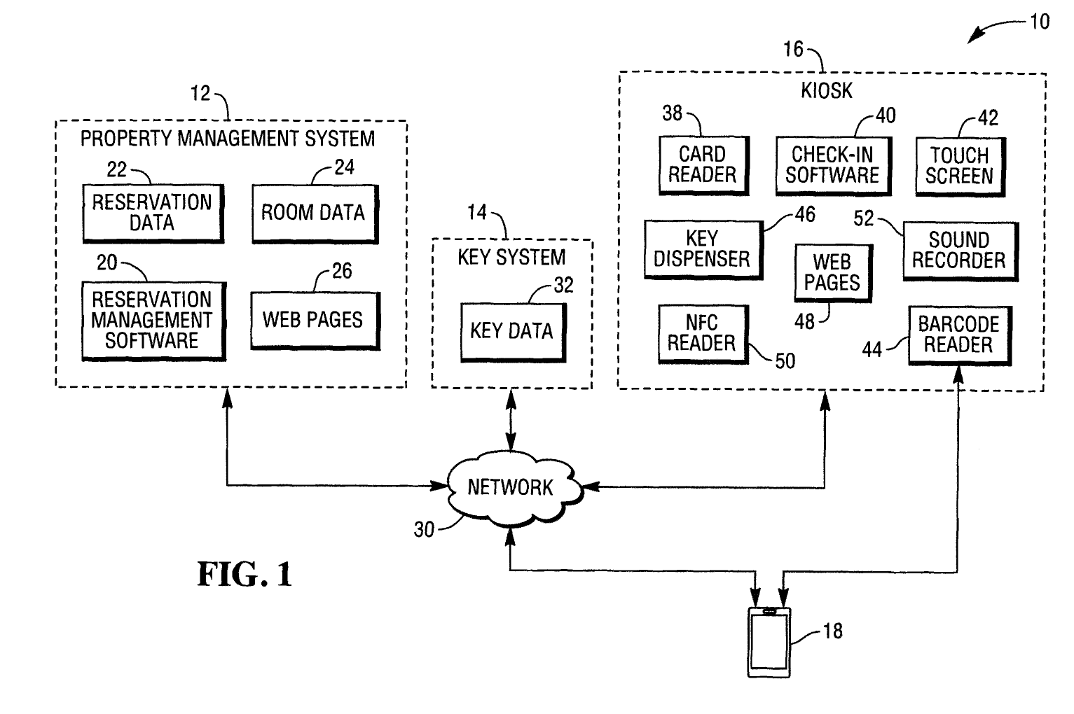

Turning now to FIG. 1, lodging management system 10 primarily includes property management system 12, key system 14, and kiosk 16.

Property management system 12 manages an inventory of rooms in a lodging establishment as room data 22, including vacant or available rooms and occupied or unavailable rooms. For this purpose, property management system 12 executes reservation management software 20. Reservation management software 20 accepts details of a planned stays, including guest identification information, dates of planned stays, payment information, room assignments, and possibly other information as reservation data 24. Property management system 12 uses the payment information to guarantee the reservation and obtain payment for the duration of the guest's stay at the lodging establishment.

Reservation management software 20 may capture a reservation from a prospective guest in advance of a planned stay. The guest may provide guest identification information and dates of planned stays. The prospective guest may also provide contact information and preferences, including a phone number, such as the phone number associated with mobile communication device 18, and/or an electronic mail or “e-mail” address.

The prospective guest may complete the reservation in a number of different ways. For example, the prospective guest may connect to property management system 12 via network 30 using mobile communication device 18, or alternatively, a personal computer. As an alternative, the prospective guest may make the reservation by calling the lodging establishment to establish a voice connection using mobile communication device 18.

Reservation management software 20 uses date information and contact information in reservation data 24 to send a message to a prospective guest. For example, before the first night of the reservation, reservation management software 20 may send an e-mail or a simple message service (SMS) or “text” message using the contact information provided by the guest when making the reservation.

The message may facilitate completion of some check-in steps that would otherwise be performed at the lodging establishment. For example, the prospective guest may respond to the message with identification information, such as name, address, and passport information, and payment information, such as credit card information. The prospective guest may further respond with requests for services, such as wireless network access, laundry, wake-up call, and other services offered by the lodging establishment.

Following receipt of check-in information, reservation management software 20 sends a confirmation message to the prospective guest containing a confirmation code validating the guest. The message may also include the information in a readable alphanumeric form. The message may include an e-mail, a text message, or a multimedia message service (MMS) or “MMS” message.

The confirmation code may contain encoded information related to the reservation, such as guest identity information, beginning and ending dates associated with the reservation, room number, and possibly other information.

An example confirmation code may include a confirmation code. The confirmation code may include a two-dimensional barcode.

Another example confirmation code may include a sound clip.

When the guest arrives at the lodging establishment, the guest uses kiosk 16 to complete the check-in process and obtain a room key.

Property management system 12 includes a processor, memory, and program and data storage. Property management system 12 may execute an operating system such as a Microsoft operating system. Property management system 12 may execute other computer software that may be stored in a computer readable medium, such as a memory. Property management system 12 may include one or more computers coupled via a network 30.

In one example embodiment, property management system 12 may include a server that hosts a World Wide Web (WWW or “web”) site capable of displaying web pages 26 and capturing information from a prospective guest via mobile communication device 18. Property management system 12 may display web pages 26 containing information about the lodging establishment, including room choices and availability. Web pages 26 may capture reservation information entered by the prospective guest using mobile communication device 18.

Network 30 may include one which uses the TCP/IP protocol. Network 30 may include a combination of local area and wide area networks. Network 30 may include any combination of wireless or wired networks. Network 30 may include a combination of private and public networks, including a global communication network, also known as the Internet.

A prospective guest wishing to make, change, or cancel a reservation uses mobile communication device 18 to connect to property management system 12 via network 30. Mobile communication device 18 receives messages from property management system 12, including the confirmation message containing the confirmation code. The prospective guest uses the smart phone to complete the check-in process at the lodging establishment using kiosk 16.

Mobile communication device 18 includes a processor, memory, and program and data storage. Mobile communication device 18 may execute an operating system. Mobile communication device 18 may execute other computer software that may be stored in a computer readable medium, such as a memory.

Mobile communication device 18 further includes graphics circuitry for connecting to a display, network circuitry for connecting to network 30, and other circuitry for connecting to other peripherals, such as an input device (e.g., a touch overlay to the display).

Mobile communication device 18 may include, but not be limited to, a smart phone, personal digital assistant, or other portable communication device.

In the example embodiment, mobile communication device 18 executes web browser software to display web pages from property management system 12.

Mobile communication device 18 may alternatively or in addition download application software to make a reservation. For example, property management system 12 may provide reservation software 28 for download from the web site hosted by property management system 12.

In one example embodiment, reservation software 28 may be written in a programming language such as the Java programming and be hosted within the browser software.

As another example, reservation software 28 may include a script, such as JavaScript, combined with hypertext markup language (HTML) or other suitable web page language.

As another example, reservation software 28 may include a software applet written to be executed within the operating system of the smart phone.

Key system 14 stores key data 32 for unlocking doors associated with each room in room data 22.

Kiosk 16 primarily includes a code reader and a key dispenser 46. Example code readers include barcode reader 44 and sound recorder 52. Barcode reader 44 reads confirmation codes displayed by mobile communication device 18. Barcode reader 44 may also read confirmation codes that have been printed on paper, for example. An example barcode reader 44 may include a charge coupled device (CCD) camera or other image capture device.

Sound recorder 52 decodes tones played by mobile communication device 18. Sound recorder 52 may include sound processing circuitry and a microphone.

Key dispenser 46 encodes and dispenses room keys.

Kiosk 16 may additionally include other peripherals, such as touch screen 42, card reader 38, and/or near field communication (NFC) reader 50 for performing additional check-in steps and/or some steps that would alternatively be performed in advance using mobile communication device 18.

Touch screen 42 displays check-in options, promotions, and helpful information, and may receive a guest selection of a number of guests/keys and a guest selection of a room.

Card reader 38 reads payment, loyalty, and other cards.

NFC reader 50 wirelessly receives radio frequency signals containing information sent by mobile communication device 18. For example, NFC reader 50 may receive payment information, loyalty information, a confirmation code, guest preferences, and other information.

Kiosk 16 executes check-in software 40. Check-in software 40 displays screens containing information for completing the check-in process using touch screen 42.

Check-in software 40 receives a confirmation code from mobile communication device 18 and compares reservation information in the confirmation code to reservation information in reservation data 24. If the reservation is valid, check-in software 40 uses room assignment information in reservation data 24 to obtain key information for programming a corresponding room key from key data 32.

For example, check-in software 40 may capture an image of a confirmation code using barcode reader 44 and decode the confirmation code.

As another example, check-in software 40 may record a confirmation tone received using sound recorder 52 and decode the confirmation tone.

As another example, check-in software 40 may wirelessly receive a confirmation a code using NFC reader 50 and decode the confirmation tone.

Check-in software 40 may prompt the guest to choose how many keys the guest requires and receives a guest selection for the number of keys via touch screen 42. Check-in software 40 operates key dispenser 46 to encode the selected number of keys with corresponding room data 32 and to dispense the keys. Finally check-in software 40 updates the guest's record in reservation data 24 to reflect that the guest has arrived and completed the check-in process.

Check-in software 40 may communicate directly with key system 14 to obtain key data 32, rather than through property management system 12.

Kiosk 16 includes a processor, memory, and program and data storage. Kiosk 16 may execute an operating system such as a Microsoft operating system. Kiosk 16 may execute other computer software that may be stored in a computer readable medium, such as a memory.

Kiosk 16 further includes graphics circuitry for connecting to a display portion of touch screen 42, network circuitry for connecting to network 30, and other circuitry for connecting to other peripherals, such as a printer, a touch overlay portion of touch screen 42. Kiosk 16 may include and use such circuitry to connect any one or more of barcode reader 44, key dispenser 46, NFC reader 50, sound recorder 52, or other peripheral necessary for the purpose of kiosk 16.

In one example embodiment, kiosk 16 executes web browser software to allow kiosk 16 to display web pages 48 for completing the check-in process. Web browser software may include commercially available web browser software, such as Microsoft® Internet Explorer web browser software.

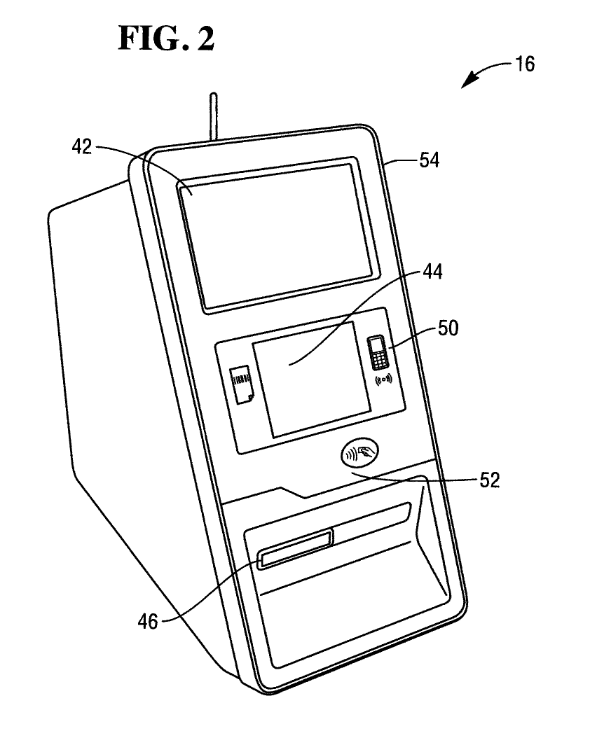

With reference to FIGS. 2-4, an example embodiment of kiosk 16 is illustrated.

Example kiosk 16 includes touch screen 42, barcode reader 44, key dispenser 46, NFC reader 50, and sound recorder 52 for capturing confirmation codes and dispensing room keys. Touch screen 42 is arranged at in an upper portion of the front surface of housing 54, key dispenser 46 is arranged in a lower portion of the front surface of housing 54, with barcode reader 44, NFC reader 50, and sound recorder 52 in between and in the front surface of housing 54.

Decals or other indicators corresponding to barcode reader 44, NFC reader 50, and sound recorder 52 are present to assist a guest with proper placement of mobile communication device 18.

Other embodiments are envisioned in which kiosk 16 includes one or more of a passport reader, a signature capture pad, a card reader, and a printer for performing additional check-in steps and/or some steps that would alternatively be performed using mobile communication device 18, such as reading a guest passport, receiving payment information and a signature, and printing a receipt, promotion, map, or other information.

Example key dispenser 46 includes a supply of unencoded credit card size room keys. The room keys may store and communicate room key data 42 in a variety of ways. For example, room keys may include magnetic stripes. Alternatively, room keys may include wireless communication circuitry, such as NFC circuitry.

A guest may choose one or more methods of completing the check-in process. A guest may display the confirmation code using mobile communication device 18 and place the displayed barcode adjacent and facing barcode reader 44. Barcode reader 44 captures an image of the barcode. Check-in software 40 decodes the barcode.

Alternatively, a guest may place mobile communication device 18 adjacent sound recorder 52 and play a confirmation tone. Sound recorder records and decodes the confirmation tone.

Alternatively, a guest may place mobile communication device 18 adjacent NFC reader 50 and transmit a confirmation code. NFC reader 50 receives and decodes the confirmation tone.

Regardless, check-in software 40 verifies decoded confirmation data against reservation data 24, obtains key data 42, and causes key dispenser 46 to encode and dispense one or more room keys.

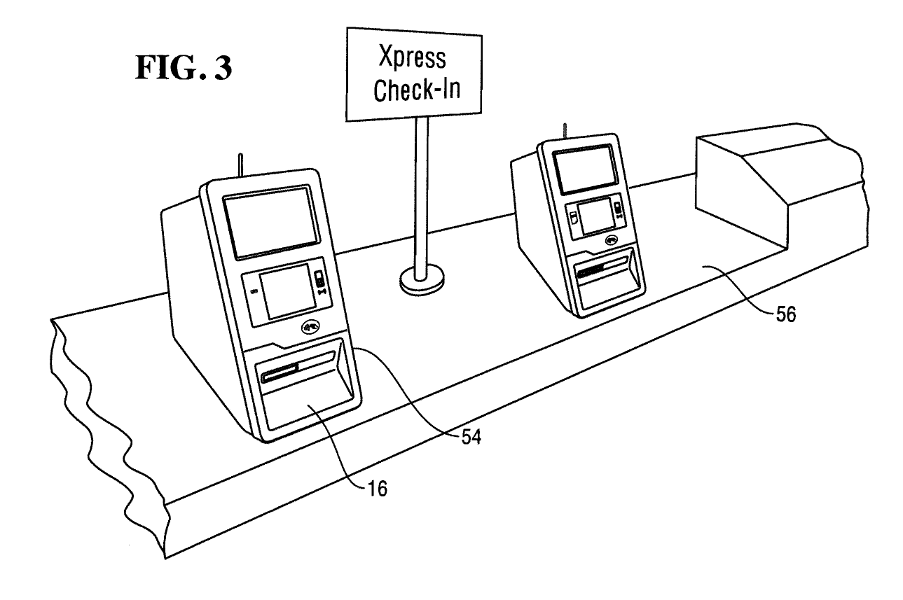

Example kiosk 16 includes a housing 54 which has a small footprint, small enough to sit on a front desk 56 (FIG. 3)

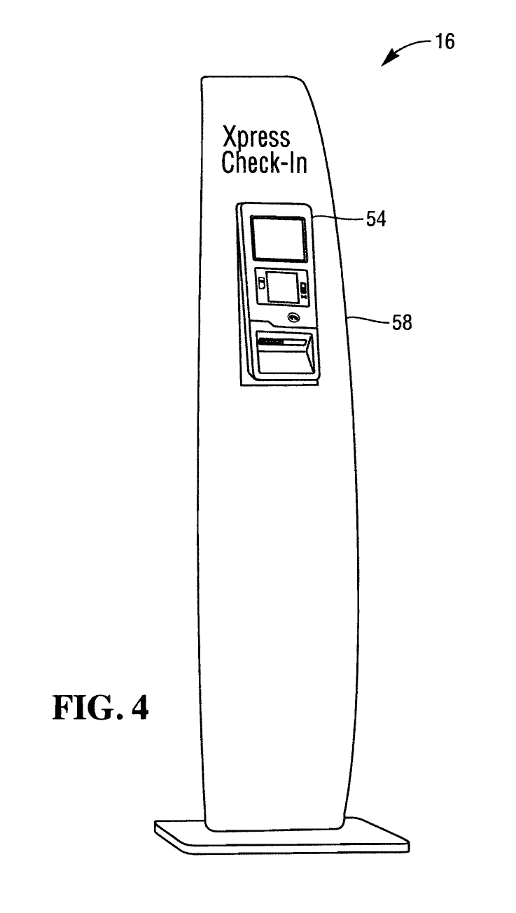

Alternatively, example housing 54 may be incorporated in a free-standing pedestal structure 58 for floor placement within the lodging establishment (FIG. 4).

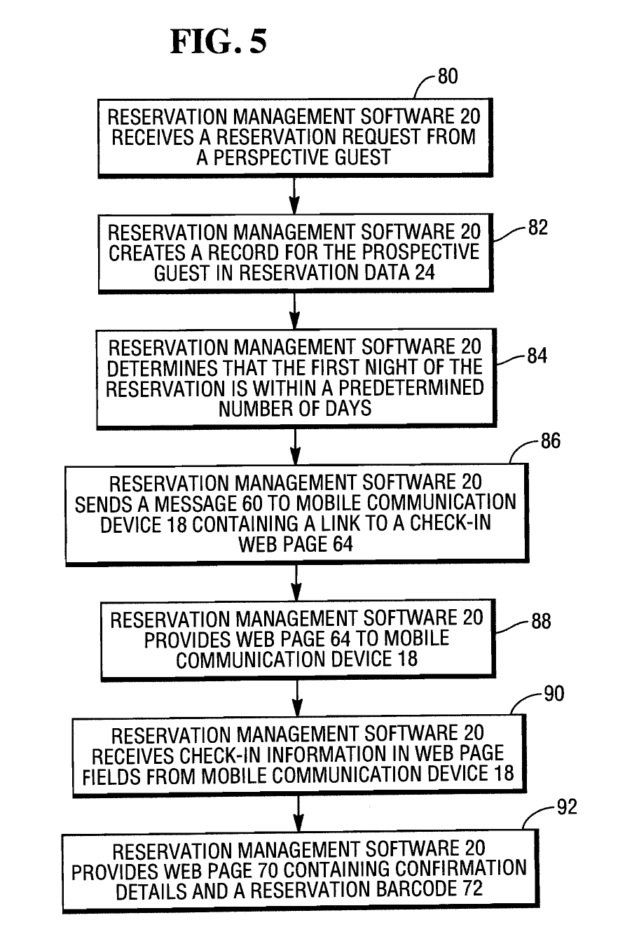

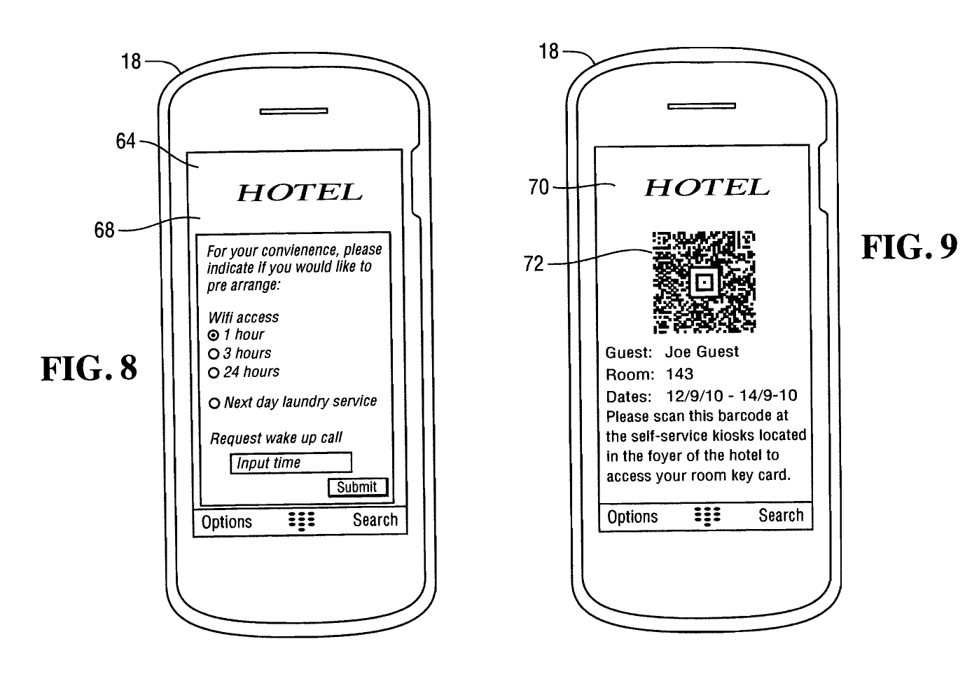

Turning now to FIGS. 5-9, an example operation of reservation management software 20 is illustrated in detail beginning with step 80.

In step 80, reservation management software 20 receives a reservation request from a prospective guest.

In step 82, reservation management software 20 creates a record for the prospective guest in reservation data 24. The record includes contact information. Reservation management software 20 may assign a room to the guest and store the room assignment in the record.

In step 84, reservation management software 20 determines from the record that the first night of the reservation is within a predetermined number of days from a current date, for example, one day.

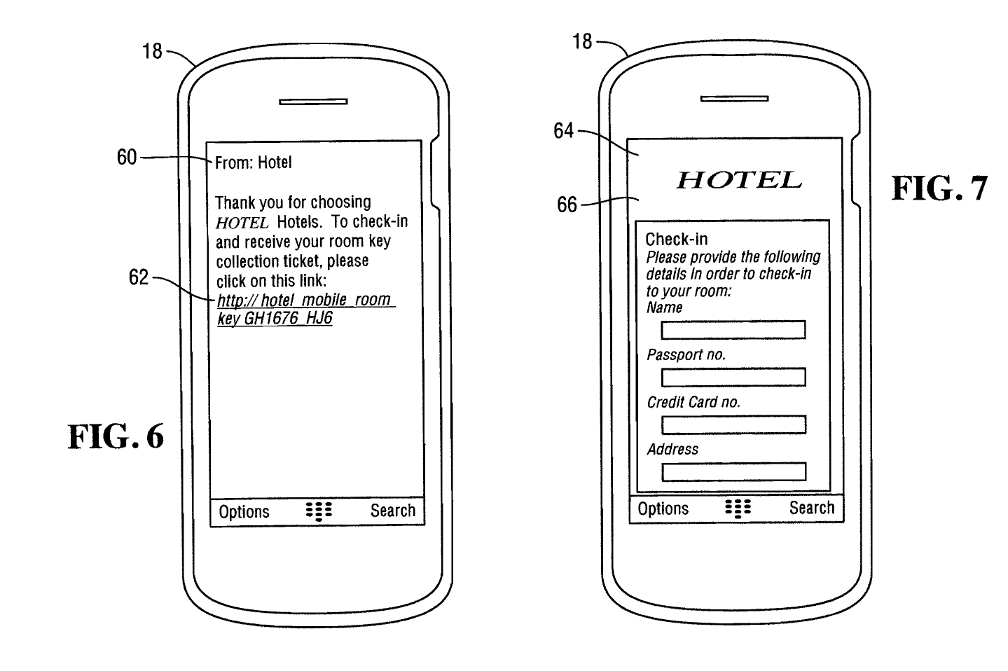

In step 86, reservation management software 20 sends a message 60 to mobile communication device 18. Message 60 includes an offer or reminder to check-in and a hyperlink 62 to a web page 64 (FIG. 6).

In step 88, reservation management software 20 provides or serves web page 64 to mobile communication device 18 when the guest selects the hyperlink. Example web page 64 includes a first portion 66 which contains fields for name, passport number, credit card number, and address. Other fields and combinations of fields are also envisioned.

Example web page 64 includes a second portion 68 which contains selections for wireless internet service and a wake-up call. Other fields and combinations of fields are also envisioned.

In step 90, reservation management software 20 receives the information in the web page fields when the guest selects a ‘submit’ button using mobile communication device 18.

In step 92, reservation management software 20 provides or serves web page 70 in response to the selection to proceed. Web page 70 contains confirmation details of the reservation and confirmation code 72, which in this example, is a two-dimensional barcode.

When the guest reaches the lodging establishment, the guest uses kiosk 16 to complete the check-in process. Check-in software 40 captures an image of confirmation code 70 from mobile communication device 18 using barcode reader 44, decodes confirmation code 70, verifies reservation information in confirmation code 70 against reservation data 24, obtains room key data 22 associated with the room assignment in verified reservation data, and operates key dispenser 46 to encode a key with key data 22 and dispense the key. The guest is now checked in.

Advantageously, guests need not stop by the front desk and wait in line to get a key. Lodging establishments may use existing room door locks.

Although the present invention has been described with particular reference to certain preferred embodiments thereof, variations and modifications of the present invention can be effected within the spirit and scope of the following claims.

1. A check-in method comprising:
creating a record of a reservation for a prospective guest including contact information associated with a mobile communication device of the prospective guest;
determining from the record that the first night of the reservation is within a predetermined number of days;
sending a message to the mobile communication device of the prospective guest using the contact information, the message including a check-in reminder and a hyperlink to a check-in web page;
providing the check-in web page to the mobile communication device in response to selection of the hyperlink by the prospective guest;
receiving check-in information entered into the check-in web page by the guest from the mobile communication device; and
providing a confirmation web page including confirmation details of the reservation and a confirmation code containing reservation information.

2. The method of claim 1, further comprising:
capturing the confirmation code from the mobile communication device;
decoding the confirmation code to obtain the reservation information;
comparing the reservation information from the confirmation code to the record to verify the reservation information from the confirmation code; and
operating a key dispenser to encode and dispense a key.

3. The method of claim 2, wherein the confirmation code comprises a barcode and the step of capturing comprises capturing an image of the barcode displayed by the mobile communication device.

4. The method of claim 2, wherein the confirmation code comprises a tone and the step of capturing comprises recording the tone played by the mobile communication device.

5. The method of claim 2, wherein the step of capturing comprises wirelessly receiving a radio frequency signal containing the confirmation code from the mobile communication device.

6. The method of claim 2, further comprising:
obtaining key data based upon verified reservation information for encoding the key.

7. A check-in system comprising:
a property management system for creating a record of a reservation for a prospective guest including contact information associated with a mobile communication device of the prospective guest, for determining from the record that the first night of the reservation is within a predetermined number of days, for sending a message to the mobile communication device of the prospective guest using the contact information, the message including a check-in reminder and a hyperlink to a check-in web page, for providing the check-in web page to the mobile communication device in response to selection of the hyperlink by the prospective guest, for receiving check-in information entered into the check-in web page by the guest from the mobile communication device, and for providing a confirmation web page including confirmation details of the reservation and a confirmation code containing reservation information.

8. A check-in kiosk comprising:
a key dispenser;
a code reader for reading a confirmation code from a mobile communication device; and
a processor for decoding the confirmation code to obtain reservation information, for comparing the reservation information from the confirmation code to a reservation record to verify the reservation information, for obtaining key data for a room in the reservation record from a key management system, and for operating the key dispenser to encode and dispense a key.

9. The kiosk of claim 8, wherein the code reader comprises a barcode reader and the confirmation code is part of a barcode.

10. The kiosk of claim 8, wherein the code reader comprises a sound recorder and the confirmation code is part of an audible tone.

11. The kiosk of claim 8, wherein the code reader comprises a wireless near field communication reader.

12. The kiosk of claim 8, further comprising a display.

13. The kiosk of claim 12, further comprising a housing including a front surface.

14. The kiosk of claim 13, wherein the display is located at a top portion of the front surface, the code reader is located at a middle portion of the front surface, and the key dispenser is located at a bottom portion of the front surface.

15. The kiosk of claim 13, further comprising an indicator on the front surface for indicating where the mobile communication device should be placed for reading by the code reader.
